(19) United States
(12) Patent Application Publication
(10) Pub. No.: US 2001/0007838 A1
(43) Pub. Date: Jul. 12, 2001

(54) Scanner driving device

(75) Inventors: Sunny Chen, Hsinchu (TW); Jer-Kuei Mai, Hsinchu (TW)

Correspondence Address: SHOEMAKER AND MATTARE, LTD., Suite 1203, Crystal Plaza Bldg. I, 2001 Jefferson Davis Highway, Arlington, VA, 22202-0286, US

(73) Assignee: UMAXDATA SYSTEMS, INC., Taiwan (CN)

(21) Appl. No.: 09/756,263

(22) Filed: Jan. 9, 2001

(30) Foreign Application Priority Data
Jan. 10, 2000 (TW) 89200322

(51) Int. Cl. F16H 7/00

(52) U.S. Cl. 474/87

(57) ABSTRACT

A scanner driving device is provided for driving an image-scanning unit mounted inside a scanner for allowing the image scanning unit to move reciprocally inside the scanner for scanning documents. The scanner driving device comprises a step motor, a belt driving mechanism interconnected between the image scanner unit and the step motor, and a control unit for controlling the step motor in response to a pre-determined scanning resolution. The step motor directly drives under the control of the control unit a timing belt pulley of the belt driving mechanism to move the image scanning unit connected to the belt driving mechanism, so that required components as well as production cost can be reduced.

### BACKGROUND OF THE INVENTION

1. Field of the Invention

The present invention relates to scanner driving device, and more particularly to a scanner driving device for driving an image scanning unit of a scanner for purpose of image scanning.

2. Description of Related Art

FIG. 1 illustrates a partial structural schematic view of a conventional scanner. As shown in FIG. 1, a guide lever 2 is installed inside a housing 1 of the scanner for guiding an image scanning unit 3 having one end movably coupled to the guide lever 2. As shown in the drawing, another end of the image scanning unit 3 positioned away from the guide lever 2 is fixed to a timing belt 40 of a belt driving device 4 for driving the image scanning unit 3 to move along the guide lever in a direction indicated by the arrow. The timing belt 40 is respectively connected to a timing belt pulley 41 coupled to a step motor 6 through a speed-reducing unit 5, and an idle pulley 42. Therefore, when the step motor 6 is activated, the speed of the step motor 6 is decelerated by the speed reducing unit 5, and the timing belt 40 is then driven to drive the image scanning unit 3 to move reciprocally along the guide lever 2.

In such a conventional scanner having aforementioned driving mechanism, the step motor 6 rotates each time by a specific angle according to a preset resolution of the scanner, so that the image scanning unit 3 can move each time with a corresponding distance responsive to the rotation of the step motor 6. However, the step angle of a conventional step motor is not small enough for driving the image scanning unit to perform a high-resolution scanning. Consequently, the speed reducing unit 5 is required to be used to reduce the step angle of the step motor 6, so as to diminish the moving distance of the image scanning unit 3 each time the image scanning unit 3 is driven by the step motor 6, to the extent that a high-resolution scanning can be performed. Furthermore, the torque of a conventional step motor is generally not sufficient to directly drive the image scanning unit 3 which typically contains a CCD and a plurality of reflecting lenses and is thereby of a considerable weight. Therefore, the speed reducing unit 5 is required to be coupled to the step motor 6 in order to enlarge the torque of the step motor 6.

The use of the speed reducing unit 5 could solve the above problem, its however, it creates other problems such as higher production costs and sophisticated assembling more complicated assembly procedures because of more components required to be used.

Furthermore, when a scanner is equipped with the speed reducing unit 5, the step motor 6 has to rotate by a preset step angle an increased number of times in order to drive the image scanning unit 3 to move a pre-determined distance. Accordingly, the scanning time for a complete scanning process is prolonged.

Moreover, as shown in FIG. 1, fixing the step motor 6 to the housing 1 by screws through protruded ears 62 of the step motor 6, as well as coupling the idle pulley 42 to the housing 1 by screws to prevent it from escape, cause the number of components to be increased and the assembling time to be lengthened.

### SUMMARY OF THE INVENTION

This invention has been designed to improve the aforementioned drawbacks of the conventional scanner. It is therefore an objective of the present invention to provide a scanner driving device for a scanner without the use of a speed reducing unit, so as to simplify the use of components and reduce production cost.

It is another objective of this invention to provide a scanner driving device that can shorten scanning time required for a complete scanning process.

It is a further objective of this invention to provide a scanner driving device that can simplify the assembling procedure and thus reduce the time required for assembly.

In accordance with the foregoing and other objectives of this invention, a scanner driving device is provided to drive an image scanning unit mounted inside a housing of a scanner, for allowing the image scanning unit to move reciprocally inside the housing. The scanner driving device comprises a belt driving mechanism including a timing belt pulley, an idle pulley rotatably installed inside the housing, and a timing belt connected to the timing belt pulley and the idle pulley; a step motor installed inside the housing and having an output shaft being axially coupled to the timing belt pulley for driving the belt connected to the belt pulley, allowing the image scanning unit connected to the belt to be synchronously moved along the extending direction of the belt; and a control unit responsive to a scanning resolution determined by a user and electrically connected to the step motor for controlling the stepping operation of the step motor.

Inside the housing is formed with an idle pulley mounting seat for fixing idle pulley in place. The idle pulley mounting seat is a snap-catch shaft protruding from the inner side of the housing, so that the idle pulley with an installing hole at its center can be engaged therewith. A motor mounting seat for fixing step motor is also formed inside the housing. The motor mounting seat formed with a twist-catch recess is a disk-like body protruding from the inner side of the housing, so that the step motor with protruding ears at its bottom can be conveniently inserted into the twist-catch recess for being twisted and fixed in position with the motor mounting seat.

Besides, the image scanning unit is preferably a light-weight color image sensor (CIS).

### BRIEF DESCRIPTION OF DRAWINGS

The invention can be fully understood by reading the following detailed description of the preferred embodiments, with reference made to the accompanying drawings, wherein:

FIG. 1 is a perspective view of a conventional scanner driving device used for a scanner;

FIG. 2 is a perspective view of the scanner driving device according to the present invention;

FIG. 3 is an exploded view of the driving device according to the present invention; and

FIG. 4 is a table showing the step angles of the step motor of the scanner driving device according to the present in response to pre-determined scanning resolutions.

### DETAILED DESCRIPTION OF PREFERRED EMBODIMENTS

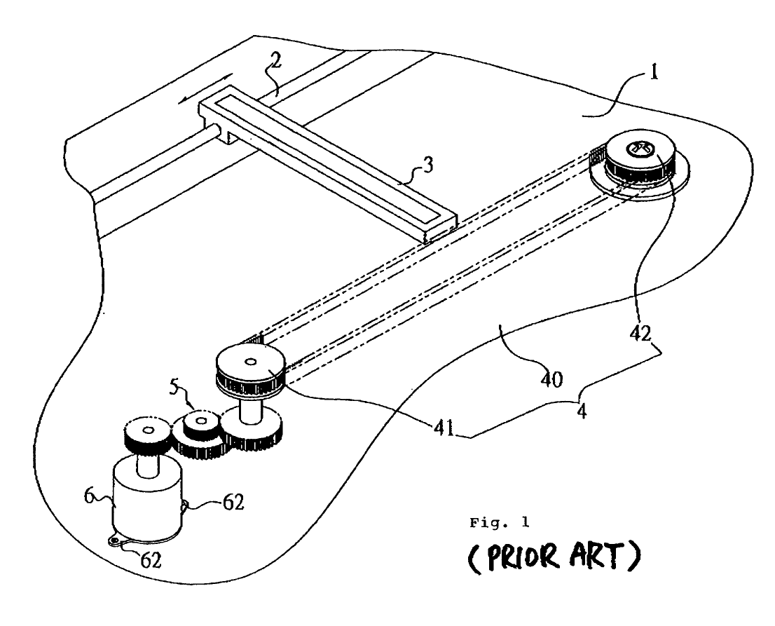

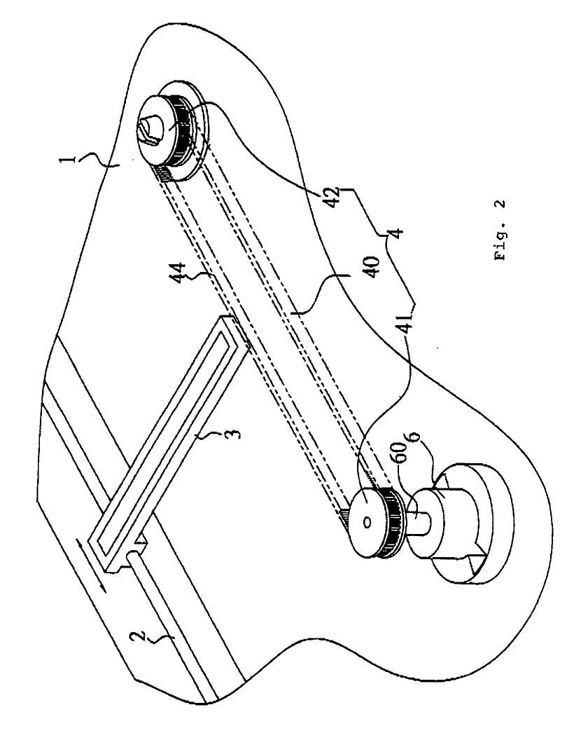

FIG. 2 is a perspective view of a scanner driving device according to the present invention, in which the components thereof corresponding to those illustrated in FIG. 1 are indicated with the same reference numerals As shown in FIG. 2, the scanner driving device of the present invention includes a timing belt pulley 41 axially coupled to an output shaft 60 of a step motor 6 for being directly driven by the step motor 6. In addition, the scanner driving device of the present invention includes a control unit (not shown) which is electrically connected with the step motor 6, for controlling the step angle of the step motor 6 according to a pre-determined scanning resolutions set by a user via the control unit.

The control unit is provided to reduce the step angle of the step motor 6 such that the image scanning unit 3 coupled to the timing belt 40 can be driven along the guide lever 2 by the step motor 6 each time by a distance sufficiently small for a scanner equipped with the scanner driving device of the present invention to perform a high-resolution scanning. As the step angle of the step motor 6 can be adjusted or set by the user via the control unit. The use of a conventional speed-reducing unit is eliminated. The assembly work and time for assembling the scanner driving device are accordingly reduced due to the use of the control unit. In order to enhance the high-resolution scanning performance of a scanner equipped with the scanner driving device of this invention, a light-weight Color Image Sensor (CIS) may be used for the image scanning unit 3 for image-capturing.

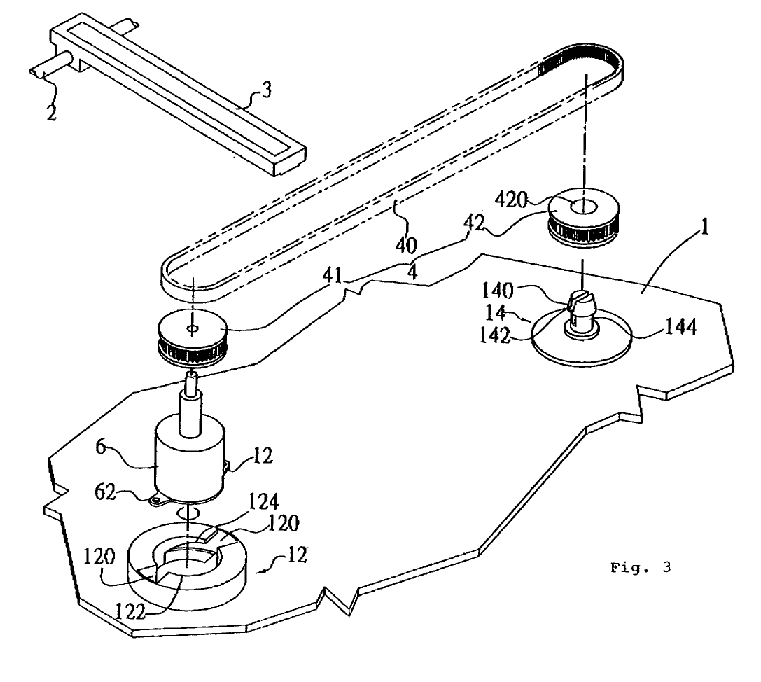

FIG. 3 is an exploded view of the scanner driving device according to the present invention. As shown in FIG. 3, for the purpose of simplifying the assembling procedures, shortening the assembling time, and reducing the components requited for the scanner driving device of the present invention, the housing 1 is integrally formed with a motor mounting seat 12 for securing the step motor 6 in place and an idle pulley mounting seat 14 for rotatably fixing the idle pulley 42.

As shown in FIG. 3, the motor mounting seat 12 is a disk-like body protruded from the inner side of the housing 1, which is formed with a notch 120 connecting an opening 122 formed in the center of the motor mounting seat 12. Below the notch 120 there are formed with a pair of twist-catch recesses 124, 124 respectively connecting the notch 120 and the opening 122 and each having a converging end. This allows the protruded ears 62, 62 formed at the bottom of the step motor 6 to pass through the notch 120 and then to securely engage the protruded ears 62, 62 with the twist-catch recesses 124, 124 by counterclockwise rotating the step motor 6. Accordingly, the lower portion of the step motor 6 is received within the opening 122, allowing the step motor 6 to be fixed to the motor mounting seat 12 without the use of screws.

The idle pulley mounting seat 14 is in the form of a snap-catch type shaft protruded from the inner side of the housing 1, and has a cone-shaped head 140 formed with a slot 142. Furthermore, the middle section of the shaft below the head 140 is formed as a bearing portion 144 corresponding to the axial hole 420 formed at the center of the idle pulley 42. By the provision of the slot 142 the head 140 of the idle pulley mounting seat 14 is allowed to pass through the axial hole 420 of the idle pulley 42 by compressing the head 140 toward the slot 142. When the head 140 passes through and protrudes from the axial hole 420, the idle pulley 42 is prevented from escaping from the idle pulley mounting seat 14 by the head 140 which has a diameter larger than the axial hole 420. Therefore, the idle pulley 42 is rotatably coupled to the idle pulley mounting seat 14.

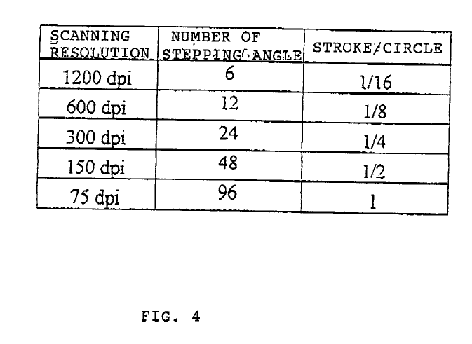

FIG. 4 illustrates how the operation of the step motor 6 responds to the scanning resolution pre-determined through the control of the control unit. When a step motor 6 has a phase number of 4, the number of rotor teeth of 24 and a step angle of 3.75 degrees, and the timing belt pulley 41 has a pitch circle radius of 5.17 mm, a pitch of 2.03 mm and the number of teeth of 16. The step motor 6 is controlled by the control unit to rotate a specific step angle responsive to the pre-determined scanning resolution. For instance, if the scanning resolution is set to be 1200 dpi, the image scanning unit 3 has to move a distance of 0.0212 mm; in this case the control unit controls the step motor 6 to rotate 6 step angles per circle (22.5 degrees or 1/16 circle) in order to drive the timing belt pulley 41 by the step motor 6 to move the timing belt 40 to move a distance of 0.0212.

In summary, the step motor of the scanner driving device of this invention is controlled by the control unit, making it capable of rotating each time by a small step angle to directly drive the timing belt pulley 41. This allows the image scanning unit to be driven by the timing belt 40 each time by a small distance sufficient for a scanner equipped with the driving device of this invention to perform a high-resolution scanning. Further, since a speed reducing unit as used in the prior art is not required the production and assembling costs are reduced.

Moreover, in the present invention, the motor mounting seat and idle pulley mounting seat are integrally formed at the inner side of the housing for a scanner, and the step motor and the idle pulley can be conveniently securely coupled thereto. Therefore, the time and effort for assembly of the step motor and the idle pulley are reduced.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A scanner driving device for driving an image scanning unit mounted inside a housing of a scanner, allowing said image scanning unit to move reciprocally inside the housing, said scanner driving device comprising:
a belt driving mechanism device including a timing belt pulley, an idle pulley rotatably mounted on an inner side of said housing, and a timing belt connected to said timing belt pulley and said idle pulley;
a step motor mounted on the inner side of said housing and having an output shaft axially coupled to said timing belt pulley for driving said timing belt to synchronously move said image scanning unit connected to said timing belt; and
a control unit electrically connected to said step motor for controlling step angles of said step motor in response to a predetermined scanning resolution set by a user via the control unit

2. The scanner driving device as claimed in claim 1, wherein as said step motor rotate through one step (one step angle), through the transmission of the belt driving device, said image scanning unit travel through a corresponding distance, then said control unit calculates a distance of each travel to be made by said image scanning unit according to required scanning resolutions to further control said step motor to rotate through a corresponding step.

3. The scanner dig device as claimed in claim 1, wherein an idle pulley mounting seat is integrally formed on the inner side of the housing, wherein said idle pulley mounting seat is in a form of a snap-catch type shaft protruded from the inner side of said housing for passing through an axial hole formed at a center of said idle pulley to thereby rotatably coupling said idle pulley to said idle pulley mounting seat.

4. The scanner driving device as claimed in claim 1, wherein a motor mounting seat is integrally protruded from the inner side of said housing, wherein said motor mounting seat is formed with a recess structure for protruded ears formed with said step motor to securely engage therewith, so as to securely fix said step motor in position to said motor mounting seat.
